(19) United States
(12) Patent Application Publication
(10) Pub. No.: US 2021/0227579 A1
(43) Pub. Date: Jul. 22, 2021

(54) METHOD AND APPARATUS FOR RANDOM ACCESS PROCEDURE WITH AN ACKNOWLEDGEMENT IN WIRELESS COMMUNICATION SYSTEM

(71) Applicant: LG Electronics Inc., Seoul (KR)

(72) Inventors: Youngdae LEE, Seoul (KR); Hyunjung CHOE, Seoul (KR)

(21) Appl. No.: 17/270,729

(22) PCT Filed: Oct. 7, 2019
(86) PCT No.: PCT/KR2019/013103

§ 371 Date: Feb. 23, 2021

Related U.S. Application Data
(60) Provisional application No. 62/742,441, filed on Oct. 7, 2018.

(51) Int. Cl. H04W 74/00; H04W 74/08; H04W 76/11; H04W 80/02; H04W 24/08; H04W 76/19; H04W 76/27; H04L 1/00; H04W 4/40

(52) U.S. Cl. CPC H04W 74/008; H04W 74/0833; H04W 76/11; H04W 80/02; H04W 4/40; H04W 76/19; H04W 76/27; H04L 1/0061; H04W 24/08

(57) ABSTRACT

A method and apparatus for random access procedure with an acknowledgement in wireless communication system is provided. A wireless device, in the wireless communication system, performs a first Random Access (RA) transmission to a network. The wireless device receives, from the network, a first Random Access Response (RAR) message in response to the first RA transmission. The wireless device attempts to decode the first RAR message. The wireless device transmits an acknowledgment (ACK) to the network based on that the first RAR message is successfully decoded. The wireless device performs a second RA transmission to the network based on that the first RAR message is not successfully decoded.

### TECHNICAL FIELD

The present disclosure relates to a method and an apparatus for random access procedure with an acknowledgement in wireless communication system.

### RELATED ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In the NR, an initial access is performed for obtaining system information, initial synchronization of downlink, and/or radio resource control (RRC) connection through a random access procedure. This is basically the same as the purpose of the initial access technology of 3GPP LTE/LTE-A. In addition, the NR includes various element technologies in the initial access procedure to support multi-beam transmission and broadband.

### SUMMARY

Due to the inherent characteristics of the NR, the initial access procedure of the NR may be different from the initial access procedure in the conventional 3GPP LTE/LTE-A. Therefore, studies for a more efficient initial access procedure are still needed.

The present disclosure is to provide a method and apparatus for performing a more efficient initial access in a wireless communication system.

In relation to this, the present disclosure proposes a method for random access procedure with an acknowledgement in a wireless communication system.

In an aspect, a method performed by a wireless device in a wireless communication system is provided. The method includes performing a first Random Access (RA) transmission to a network. The method includes receiving, from the network, a first Random Access Response (RAR) message in response to the first RA transmission. The method includes attempting to decode the first RAR message. The method includes transmitting an acknowledgment (ACK) to the network based on that the first RAR message is successfully decoded. The method includes performing a second RA transmission to the network based on that the first RAR message is not successfully decoded.

In another aspect, a wireless device in a wireless communication system is provided. The wireless device includes a memory, a transceiver, and a processor, operably coupled to the memory and the transceiver. The processor is configured to perform a first Random Access (RA) transmission to a network. The processor is configured to control the transceiver to receive, from the network, a first Random Access Response (RAR) message in response to the first RA transmission. The processor is configured to attempt to decode the first RAR message. The processor is configured to control the transceiver to transmit an acknowledgment (ACK) to the network based on that the first RAR message is successfully decoded. The processor is configured to perform a second RA transmission to the network based on that the first RAR message is not successfully decoded.

The present disclosure can have various advantageous effects.

According to some embodiments of the present disclosure, a wireless device may save an effort, such as a time and a battery, for decoding the second RAR message after transmitting an ACK for the first RAR message.

According to some embodiments of the present disclosure, a network may save a resource, by configuring a RAR message based on ACK(s) from one or more of wireless device(s).

According to some embodiments of the present disclosure, a network may save a resource for a message 4 when the message 4 is not needed. In addition, a wireless device may save a time and a battery to monitoring the message 4.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows examples of 5G usage scenarios to which the technical features of the present disclosure can be applied.

FIG. 2 shows an example of a wireless communication system to which the technical features of the present disclosure can be applied.

FIG. 3 shows another example of a wireless communication system to which the technical features of the present disclosure can be applied.

FIG. 4 shows another example of a wireless communication system to which the technical features of the present disclosure can be applied.

FIG. 5 shows a block diagram of a user plane protocol stack to which the technical features of the present disclosure can be applied.

FIG. 6 shows a block diagram of a control plane protocol stack to which the technical features of the present disclosure can be applied.

FIG. 7A and FIG. 7B show an example of a method for receiving unicast downlink data before or without entering RRC_CONNECTED, according to some embodiments of the present disclosure.

FIG. 8 shows an example of a method for random access procedure according to some embodiments of the present disclosure.

FIG. 9 shows an apparatus to which the technical features of the present disclosure can be applied.

FIG. 10 shows an example of an AI device to which the technical features of the present disclosure can be applied.

FIG. 11 shows an example of an AI system to which the technical features of the present disclosure can be applied.

### DESCRIPTION

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (UL). For example, only OFDMA may be used for DL and only SC-FDMA may be used for UL. Alternatively, OFDMA and SC-FDMA may be used for DL and/or UL.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A, B, C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

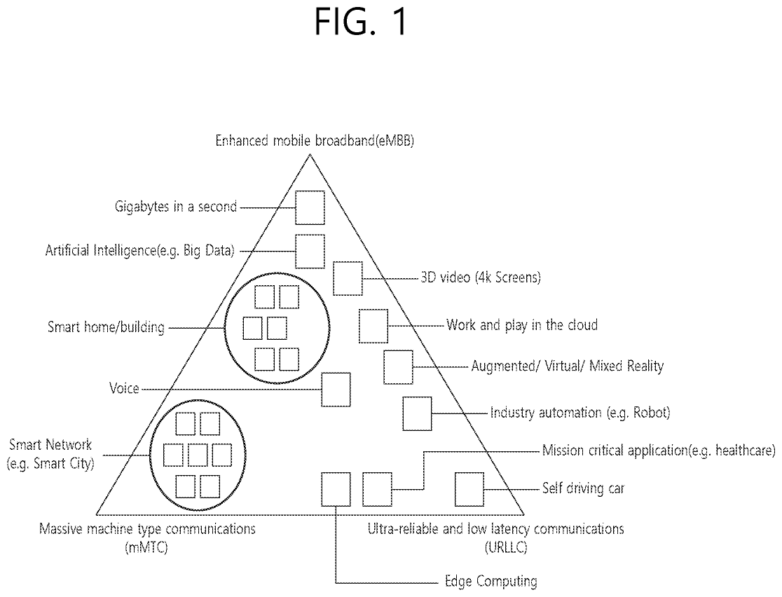

FIG. 1 shows examples of 5G usage scenarios to which the technical features of the present disclosure can be applied.

The 5G usage scenarios shown in FIG. 1 are only exemplary, and the technical features of the present disclosure can be applied to other 5G usage scenarios which are not shown in FIG. 1.

Referring to FIG. 1, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or −1 million devices/km2. mMTC allows seamless integration of embedded sensors in all areas and is one of the most widely used 5G applications. Potentially by 2020, internet-of-things (IoT) devices are expected to reach 20.4 billion. Industrial IoT is one of the areas where 5G plays a key role in enabling smart cities, asset tracking, smart utilities, agriculture, and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. 1 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time high-definition (HD) video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems.

Use cases of logistics and freight tracking typically require low data rates, but require a large range and reliable location information.

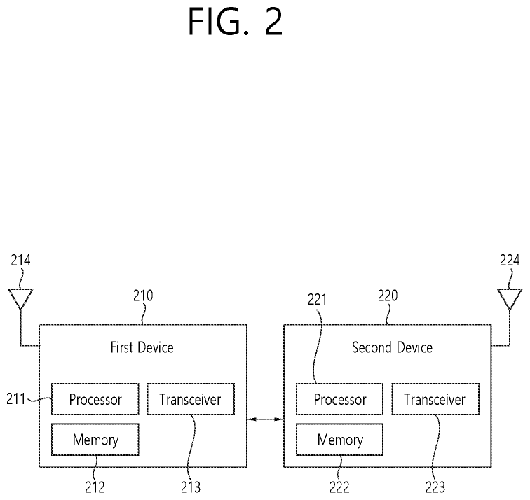

FIG. 2 shows an example of a wireless communication system to which the technical features of the present disclosure can be applied.

Referring to FIG. 2, the wireless communication system may include a first device 210 and a second device 220.

The first device 210 includes a base station, a network node, a transmitting UE, a receiving UE, a wireless device, a wireless communication device, a vehicle, a vehicle equipped with an autonomous driving function, a connected car, a drone, an unmanned aerial vehicle (UAV), an artificial intelligence (AI) module, a robot, an AR device, a VR device, a mixed reality (MR) device, a hologram device, a public safety device, an MTC device, an IoT device, a medical device, a fin-tech device (or, a financial device), a security device, a climate/environmental device, a device related to 5G services, or a device related to the fourth industrial revolution.

The second device 220 includes a base station, a network node, a transmitting UE, a receiving UE, a wireless device, a wireless communication device, a vehicle, a vehicle equipped with an autonomous driving function, a connected car, a drone, a UAV, an AI module, a robot, an AR device, a VR device, an MR device, a hologram device, a public safety device, an MTC device, an IoT device, a medical device, a fin-tech device (or, a financial device), a security device, a climate/environmental device, a device related to 5G services, or a device related to the fourth industrial revolution.

For example, the UE may include a mobile phone, a smart phone, a laptop computer, a digital broadcasting terminal, a personal digital assistant (PDA), a portable multimedia player (PMP), a navigation device, a slate personal computer (PC), a tablet PC, an ultrabook, a wearable device (e.g. a smartwatch, a smart glass, a head mounted display (HMD)). For example, the HMD may be a display device worn on the head. For example, the HMD may be used to implement AR, VR and/or MR.

For example, the drone may be a flying object that is flying by a radio control signal without a person boarding it. For example, the VR device may include a device that implements an object or background in the virtual world. For example, the AR device may include a device that implements connection of an object and/or a background of a virtual world to an object and/or a background of the real world. For example, the MR device may include a device that implements fusion of an object and/or a background of a virtual world to an object and/or a background of the real world. For example, the hologram device may include a device that implements a 360-degree stereoscopic image by recording and playing stereoscopic information by utilizing a phenomenon of interference of light generated by the two laser lights meeting with each other, called holography. For example, the public safety device may include a video relay device or a video device that can be worn by the user's body. For example, the MTC device and the IoT device may be a device that do not require direct human intervention or manipulation. For example, the MTC device and the IoT device may include a smart meter, a vending machine, a thermometer, a smart bulb, a door lock and/or various sensors. For example, the medical device may be a device used for the purpose of diagnosing, treating, alleviating, handling, or preventing a disease. For example, the medical device may be a device used for the purpose of diagnosing, treating, alleviating, or correcting an injury or disorder. For example, the medical device may be a device used for the purpose of inspecting, replacing or modifying a structure or function. For example, the medical device may be a device used for the purpose of controlling pregnancy. For example, the medical device may include a treatment device, a surgical device, an (in vitro) diagnostic device, a hearing aid and/or a procedural device, etc. For example, a security device may be a device installed to prevent the risk that may occur and to maintain safety. For example, the security device may include a camera, a closed-circuit TV (CCTV), a recorder, or a black box. For example, the fin-tech device may be a device capable of providing financial services such as mobile payment. For example, the fin-tech device may include a payment device or a point of sales (POS). For example, the climate/environmental device may include a device for monitoring or predicting the climate/environment.

The first device 210 may include at least one or more processors, such as a processor 211, at least one memory, such as a memory 212, and at least one transceiver, such as a transceiver 213. The processor 211 may perform the functions, procedures, and/or methods of the present disclosure described below. The processor 211 may perform one or more protocols. For example, the processor 211 may perform one or more layers of the air interface protocol. The memory 212 is connected to the processor 211 and may store various types of information and/or instructions. The transceiver 213 is connected to the processor 211 and may be controlled to transmit and receive wireless signals.

The second device 220 may include at least one or more processors, such as a processor 221, at least one memory, such as a memory 222, and at least one transceiver, such as a transceiver 223. The processor 221 may perform the functions, procedures, and/or methods of the present disclosure described below. The processor 221 may perform one or more protocols.

For example, the processor 221 may perform one or more layers of the air interface protocol. The memory 222 is connected to the processor 221 and may store various types of information and/or instructions. The transceiver 223 is connected to the processor 221 and may be controlled to transmit and receive wireless signals.

The memory 212, 222 may be connected internally or externally to the processor 211, 221, or may be connected to other processors via a variety of technologies such as wired or wireless connections.

The first device 210 and/or the second device 220 may have more than one antenna. For example, antenna 214 and/or antenna 224 may be configured to transmit and receive wireless signals.

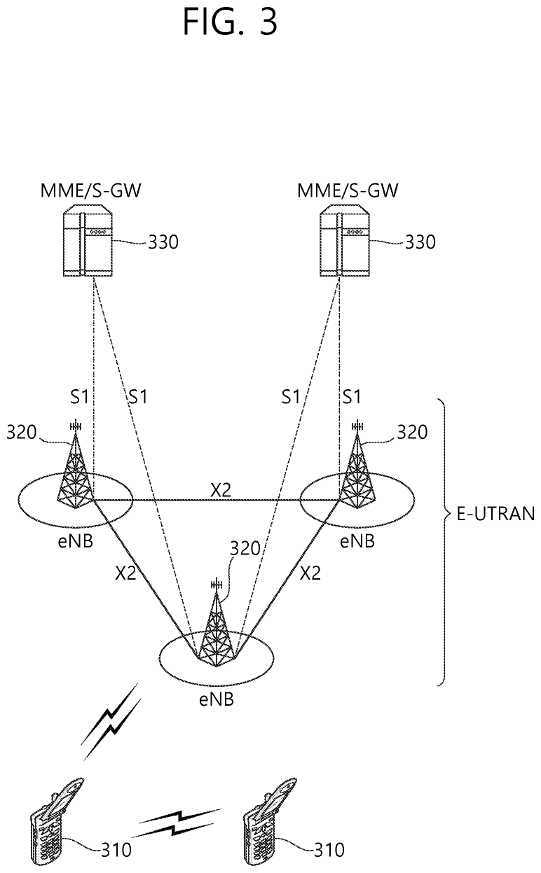

FIG. 3 shows another example of a wireless communication system to which the technical features of the present disclosure can be applied.

Specifically, FIG. 3 shows a system architecture based on an evolved-UMTS terrestrial radio access network (E-UTRAN). The aforementioned LTE is a part of an evolved-UTMS (e-UMTS) using the E-UTRAN.

Referring to FIG. 3, the wireless communication system includes one or more user equipment (UE) 310, an E-UTRAN and an evolved packet core (EPC). The UE 310 refers to a communication equipment carried by a user. The UE 310 may be fixed or mobile. The UE 310 may be referred to as another terminology, such as a mobile station (MS), a user terminal (UT), a subscriber station (SS), and a wireless device, etc.

The E-UTRAN consists of one or more evolved NodeB (eNB) 320. The eNB 320 provides the E-UTRA user plane and control plane protocol terminations towards the UE 10. The eNB 320 is generally a fixed station that communicates with the UE 310. The eNB 320 hosts the functions, such as inter-cell radio resource management (RRM), radio bearer (RB) control, connection mobility control, radio admission control, measurement configuration/provision, dynamic resource allocation (scheduler), etc. The eNB 320 may be referred to as another terminology, such as a base station (BS), a base transceiver system (BTS), an access point (AP), etc.

A downlink (DL) denotes communication from the eNB 320 to the UE 310. An uplink (UL) denotes communication from the UE 310 to the eNB 320. A sidelink (SL) denotes communication between the UEs 310. In the DL, a transmitter may be a part of the eNB 320, and a receiver may be a part of the UE 310. In the UL, the transmitter may be a part of the UE 310, and the receiver may be a part of the eNB 320. In the SL, the transmitter and receiver may be a part of the UE 310.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 330 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 310 is connected to the eNB 320 by means of the Uu interface. The UEs 310 are interconnected with each other by means of the PC5 interface. The eNBs 320 are interconnected with each other by means of the X2 interface. The eNBs 320 are also connected by means of the S1 interface to the EPC, more specifically to the MME by means of the S1-MME interface and to the S-GW by means of the S1-U interface. The S1 interface supports a many-to-many relation between MMEs/S-GWs and eNBs.

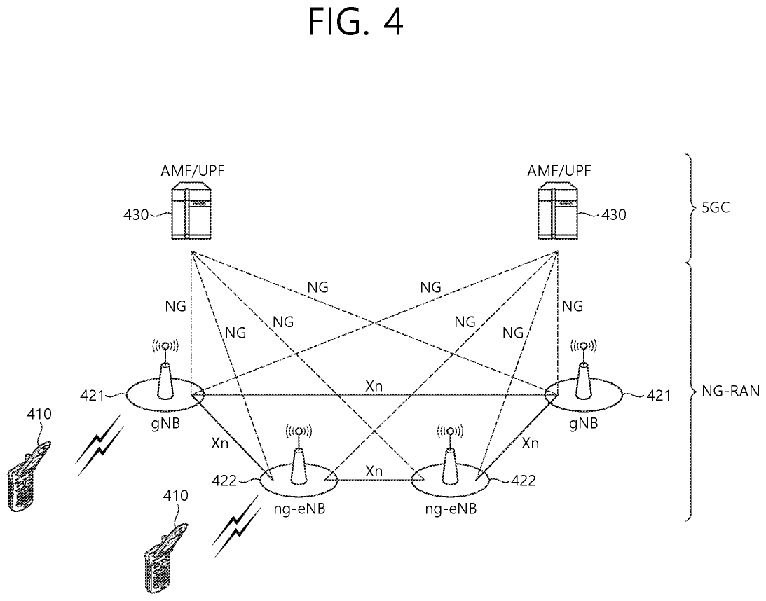

FIG. 4 shows another example of a wireless communication system to which the technical features of the present disclosure can be applied.

Specifically, FIG. 4 shows a system architecture based on a 5G NR. The entity used in the 5G NR (hereinafter, simply referred to as “NW”) may absorb some or all of the functions of the entities introduced in FIG. 3 (e.g. eNB, MME, S-GW). The entity used in the NR may be identified by the name “NG” for distinction from the LTE/LTE-A.

Referring to FIG. 4, the wireless communication system includes one or more UE 410, a next-generation RAN (NG-RAN) and a 5th generation core network (5GC). The NG-RAN consists of at least one NG-RAN node. The NG-RAN node is an entity corresponding to the eNB 320 shown in FIG. 3. The NG-RAN node consists of at least one gNB 421 and/or at least one ng-eNB 422. The gNB 421 provides NR user plane and control plane protocol terminations towards the UE 410. The ng-eNB 422 provides E-UTRA user plane and control plane protocol terminations towards the UE 410.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional 5-GW. The SMF hosts the functions, such as UE IP address allocation, PDU session control.

The gNBs 421 and ng-eNBs 422 are interconnected with each other by means of the Xn interface. The gNBs 421 and ng-eNBs 422 are also connected by means of the NG interfaces to the 5GC, more specifically to the AMF by means of the NG-C interface and to the UPF by means of the NG-U interface.

A protocol structure between network entities described above is described. On the system of FIG. 3 and/or FIG. 4, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

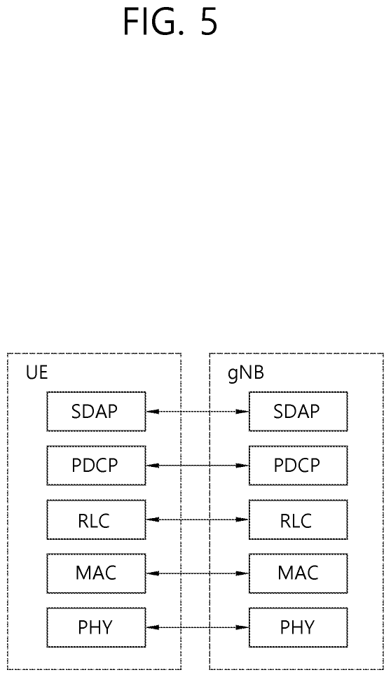

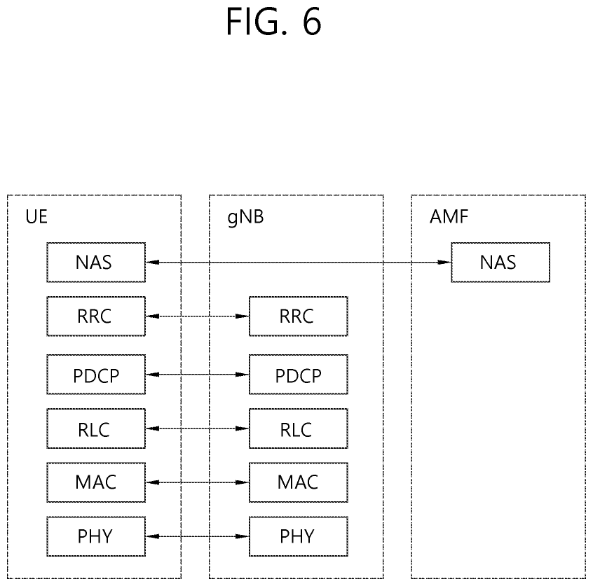

FIG. 5 shows a block diagram of a user plane protocol stack to which the technical features of the present disclosure can be applied. FIG. 6 shows a block diagram of a control plane protocol stack to which the technical features of the present disclosure can be applied.

The user/control plane protocol stacks shown in FIG. 5 and FIG. 6 are used in NR. However, user/control plane protocol stacks shown in FIG. 5 and FIG. 6 may be used in LTE/LTE-A without loss of generality, by replacing gNB/AMF with eNB/MME.

Referring to FIG. 5 and FIG. 6, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/demultiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC_connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5 GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

NR supports multiple numerology (or, subcarrier spacing (SCS)) to support various 5G services. For example, when the SCS is 15 kHz, wide area in traditional cellular bands may be supported. When the SCS is 30 kHz/60 kHz, dense-urban, lower latency and wider carrier bandwidth may be supported. When the SCS is 60 kHz or higher, a bandwidth greater than 24.25 GHz may be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, random access procedure, by a wireless device, will be described. It may be referred to as Section 5.1 of 3GPP TS 38.321 V15.3.0 (2018 September). Random Access procedure initialization is described. The Random Access procedure described in this subclause is initiated by a PDCCH order, by the MAC entity itself, or by RRC. There is only one Random Access procedure ongoing at any point in time in a MAC entity. The Random Access procedure on a SCell shall only be initiated by a PDCCH order with ra-Preamblelndex different from 0b000000.

If the MAC entity receives a request for a new Random Access procedure while another is already ongoing in the MAC entity, it is up to UE implementation whether to continue with the ongoing procedure or start with the new procedure (e.g. for SI request).

The following UE variables are used for the Random Access procedure:
PREAMBLE_INDEX;
PREAMBLE_TRANSMISSION_COUNTER;
PREAMBLE_POWER_RAMPING_COUNTER;
PREAMBLE_POWER_RAMPING_STEP;
PREAMBLE_RECEIVED_TARGET_POWER;
PREAMBLE_BACKOFF;
PCMAX;
SCALING_FACTOR_BI;
TEMPORARY_C-RNTI.

When the Random Access procedure is initiated on a Serving Cell, the MAC entity shall:

1> flush the Msg3 buffer;

1> set the PREAMBLE_TRANSMISSION_COUNTER to 1;

1> set the PREAMBLE_POWER_RAMPING_COUNTER to 1;

1> set the PREAMBLE_BACKOFF to 0 ms;

1> if the carrier to use for the Random Access procedure is explicitly signalled:

2> select the signalled carrier for performing Random Access procedure;

2> set the PCMAX to PCMAX,f,c of the signalled carrier.

1> else if the carrier to use for the Random Access procedure is not explicitly signalled; and

1> if the Serving Cell for the Random Access procedure is configured with supplementaryUplink; and

1> if the RSRP of the downlink pathloss reference is less than rsrp-ThresholdSSB-SUL:

2> select the SUL carrier for performing Random Access procedure;

2> set the PCMAX to PCMAX,f,c of the SUL carrier.

1> else:

2> select the NUL carrier for performing Random Access procedure;

2> set the PCMAX to PCMAX,f,c of the NUL carrier.

1> set PREAMBLE POWER RAMPING STEP to powerRampingStep;

1> if powerRampingStepHighPriority is configured:

2> if the Random Access procedure was initiated for beam failure recovery; or

2> if the Random Access procedure was initiated for handover:

3> set the PREAMBLE POWER RAMPING STEP to powerRampingStepHighPriority;

1> set SCALING FACTOR BI to 1;

1> if scalingFactorBI is configured:

2> if the Random Access procedure was initiated for beam failure recovery; or

2> if the Random Access procedure was initiated for handover:

3> set the SCALING FACTOR BI to scalingFactorBI;

1> perform the Random Access Resource selection procedure.

Random Access Resource selection is described.

The MAC entity shall:

1> if the Random Access procedure was initiated for beam failure recovery; and

1> if the beamFailureRecoveryTimer is either running or not configured; and

1> if the contention-free Random Access Resources for beam failure recovery request associated with any of the SSBs and/or CSI-RSs have been explicitly provided by RRC; and

1> if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:

2> select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;

2> if CSI-RS is selected, and there is no ra-Preamblelndex associated with the selected CSI-RS:

3> set the PREAMBLE_INDEX to a ra-PreambleIndex corresponding to the SSB in candidateBeamRSList which is quasi-collocated with the selected CSI-RS.

2> else:

3> set the PREAMBLE_INDEX to a ra-Preamblelndex corresponding to the selected SSB or CSI-RS from the set of Random Access Preambles for beam failure recovery request.

1> else if the ra-Preamblelndex has been explicitly provided by PDCCH; and

1> if the ra-Preamblelndex is not 0b000000:

2> set the PREAMBLE_INDEX to the signalled ra-Preamblelndex;

2> select the SSB signalled by PDCCH.

1> else if the contention-free Random Access Resources associated with SSBs have been explicitly provided by RRC and at least one SSB with SS-RSRP above rsrp-ThresholdSSB amongst the associated SSBs is available:

2> select an SSB with SS-RSRP above rsrp-ThresholdSSB amongst the associated SSBs;

2> set the PREAMBLE_INDEX to a ra-Preamblelndex corresponding to the selected SSB.

1> else if the contention-free Random Access Resources associated with CSI-RSs have been explicitly provided by RRC and at least one CSI-RS with CSI-RSRP above rsrp-ThresholdCSI-RS amongst the associated CSI-RSs is available:

2> select a CSI-RS with CSI-RSRP above rsrp-ThresholdCSI-RS amongst the associated CSI-RSs;

2> set the PREAMBLE_INDEX to a ra-Preamblelndex corresponding to the selected CSI-RS.

1> else if the Random Access procedure was initiated for SI request; and

1> if the Random Access Resources for SI request have been explicitly provided by RRC:

2> if at least one of the SSBs with SS-RSRP above rsrp-ThresholdSSB is available:

3> select an SSB with SS-RSRP above rsrp-ThresholdSSB.

2> else:

3> select any SSB.

2> select a Random Access Preamble corresponding to the selected SSB, from the Random Access Preamble(s) determined according to ra-PreambleStartIndex;

2> set the PREAMBLE_INDEX to selected Random Access Preamble.

1> else (i.e. for the contention-based Random Access preamble selection):

2> if at least one of the SSBs with SS-RSRP above rsrp-ThresholdSSB is available:

3> select an SSB with SS-RSRP above rsrp-ThresholdSSB.

2> else:

3> select any SSB.

2> if Msg3 has not yet been transmitted:

3> if Random Access Preambles group B is configured:

4> if the potential Msg3 size (UL data available for transmission plus MAC header and, where required, MAC CEs) is greater than ra-Msg3SizeGroupA and the pathloss is less than PCMAX (of the Serving Cell performing the Random Access Procedure)-preambleReceivedTargetPower-msg3-DeltaPreamble-messagePowerOffsetGroupB; or

4> if the Random Access procedure was initiated for the CCCH logical channel and the CCCH SDU size plus MAC subheader is greater than ra-Msg3SizeGroupA:

5> select the Random Access Preambles group B.

4> else:

5> select the Random Access Preambles group A.

3> else:

4> select the Random Access Preambles group A.

2> else (i.e. Msg3 is being retransmitted):

3> select the same group of Random Access Preambles as was used for the Random Access Preamble transmission attempt corresponding to the first transmission of Msg3.

2> if the association between Random Access Preambles and SSBs is configured:

3> select a Random Access Preamble randomly with equal probability from the Random Access Preambles associated with the selected SSB and the selected Random Access Preambles group.

2> else:

3> select a Random Access Preamble randomly with equal probability from the Random Access Preambles within the selected Random Access Preambles group.

2> set the PREAMBLE_INDEX to the selected Random Access Preamble.

1> if the Random Access procedure was initiated for SI request; and

1> if ra-AssociationPeriodlndex and si-RequestPeriod are configured:

2> determine the next available PRACH occasion from the PRACH occasions corresponding to the selected SSB in the association period given by ra-AssociationPeriodlndex in the si-RequestPeriod permitted by the restrictions given by the ra-ssb-OccasionMasklndex (the MAC entity shall select a PRACH occasion randomly with equal probability amongst the consecutive PRACH occasions corresponding to the selected SSB).

1> else if an SSB is selected above:

2> determine the next available PRACH occasion from the PRACH occasions corresponding to the selected SSB permitted by the restrictions given by the ra-ssb-OccasionMasklndex if configured (the MAC entity shall select a PRACH occasion randomly with equal probability amongst the consecutive PRACH occasions, corresponding to the selected SSB; the MAC entity may take into account the possible occurrence of measurement gaps when determining the next available PRACH occasion corresponding to the selected SSB).

1> else if a CSI-RS is selected above:

2> if there is no contention-free Random Access Resource associated with the selected CSI-RS:

3> determine the next available PRACH occasion from the PRACH occasions, permitted by the restrictions given by the ra-ssb-OccasionMasklndex if configured, corresponding to the SSB in candidateBeamRSList which is quasi-collocated with the selected CSI-RS (the MAC entity may take into account the possible occurrence of measurement gaps when determining the next available PRACH occasion corresponding to the SSB which is quasi-collacted with the selected CSI-RS).

2> else:

3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).

1> perform the Random Access Preamble transmission procedure.

When the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

Random Access Preamble transmission is described.

The MAC entity shall, for each Random Access Preamble:

1> if PREAMBLE_TRANSMISSION_COUNTER is greater than one; and

1> if the notification of suspending power ramping counter has not been received from lower layers; and

1> if SSB selected is not changed (i.e. same as the previous Random Access Preamble transmission):

2> increment PREAMBLE_POWER _RAMPING_COUNTER by 1.

1> select the value of DELTA_PREAMBLE;

1> set PREAMBLE_RECEIVED_TARGET _POWER to preambleReceivedTargetPower+DELTA_PREAMBLE+(PREAMBLE_POWER _RAMPING_COUNTER 1)×PREAMBLE_POWER _RAMPING_STEP;

1> except for contention-free Random Access Preamble for beam failure recovery request, compute the RA-RNTI associated with the PRACH occasion in which the Random Access Preamble is transmitted;

1> instruct the physical layer to transmit the Random Access Preamble using the selected PRACH, corresponding RA-RNTI (if available), PREAMBLE_INDEX and PREAMBLE RECEIVED TARGET POWER.

The RA-RNTI associated with the PRACH in which the Random Access Preamble is transmitted, is computed as:

RA-RNTI=1+s_id+14*t_id+14*80*f_id+14*80*8×ul_carrier_id

where s_id is the index of the first OFDM symbol of the specified PRACH (0≤s_id <14), t_id is the index of the first slot of the specified PRACH in a system frame (0≤t_id<80), f_id is the index of the specified PRACH in the frequency domain (0≤f_id <8), and ul_carrier_id is the UL carrier used for Msg1 transmission (0 for NUL carrier, and 1 for SUL carrier).

Random Access Response reception is described.

Once the Random Access Preamble is transmitted and regardless of the possible occurrence of a measurement gap, the MAC entity shall:

1> if the contention-free Random Access Preamble for beam failure recovery request was transmitted by the MAC entity:

2> start the ra-ResponseWindow configured in BeamFailureRecoveryConfig at the first PDCCH occasion from the end of the Random Access Preamble transmission;

2> monitor the PDCCH of the SpCell for response to beam failure recovery request identified by the C-RNTI while ra-ResponseWindow is running.

1> else:

2> start the ra-ResponseWindow configured in RACH-ConfigCommon at the first PDCCH occasion from the end of the Random Access Preamble transmission;

2> monitor the PDCCH of the SpCell for Random Access Response(s) identified by the RA-RNTI while the ra-ResponseWindow is running.

1> if notification of a reception of a PDCCH transmission is received from lower layers on the Serving Cell where the preamble was transmitted; and

1> if PDCCH transmission is addressed to the C-RNTI; and

1> if the contention-free Random Access Preamble for beam failure recovery request was transmitted by the MAC entity:

2> consider the Random Access procedure successfully completed.

1> else if a downlink assignment has been received on the PDCCH for the RA-RNTI and the received TB is successfully decoded:

2> if the Random Access Response contains a MAC subPDU with Backoff Indicator:

3> set the PREAMBLE BACKOFF to value of the BI field of the MAC subPDU multiplied with SCALING FACTOR BI.

2> else:

3> set the PREAMBLE BACKOFF to 0 ms.

2> if the Random Access Response contains a MAC subPDU with Random Access Preamble identifier corresponding to the transmitted PREAMBLE_:

3> consider this Random Access Response reception successful.

2> if the Random Access Response reception is considered successful:

3> if the Random Access Response includes a MAC subPDU with RAPID only:

4> consider this Random Access procedure successfully completed;

4> indicate the reception of an acknowledgement for SI request to upper layers.

3> else:

4> apply the following actions for the Serving Cell where the Random Access Preamble was transmitted:

5> process the received Timing Advance Command;

5> indicate the preambleReceivedTargetPower and the amount of power ramping applied to the latest Random Access Preamble transmission to lower layers (i.e. (PREAMBLE_POWER_RAMPING _COUNTER−1)×PREAMBLE_POWER_RAMPING _STEP);

5> if the Serving Cell for the Random Access procedure is SRS-only SCell:

6> ignore the received UL grant.

5> else:

6> process the received UL grant value and indicate it to the lower layers.

4> if the Random Access Preamble was not selected by the MAC entity among the contention-based Random Access Preamble(s):

5> consider the Random Access procedure successfully completed.

4> else:

5> set the TEMPORARY C-RNTI to the value received in the Random Access Response;

5> if this is the first successfully received Random Access Response within this Random Access procedure:

6> if the transmission is not being made for the CCCH logical channel:

7> indicate to the Multiplexing and assembly entity to include a C-RNTI MAC CE in the subsequent uplink transmission.

6> obtain the MAC PDU to transmit from the Multiplexing and assembly entity and store it in the Msg3 buffer.

1> if ra-ResponseWindow configured in RACH-ConfigCommon expires, and if the Random Access Response containing Random Access Preamble identifiers that matches the transmitted PREAMBLE_INDEX has not been received; or

1> if ra-ResponseWindow configured in BeamFailureRecoveryConfig expires and if the PDCCH addressed to the C-RNTI has not been received on the Serving Cell where the preamble was transmitted:

2> consider the Random Access Response reception not successful;

2> increment PREAMBLE_TRANSMISSION_COUNTER by 1;

2> if PREAMBLE_TRANSMISSION_COUNTER=preambleTransMax+1:

3> if the Random Access Preamble is transmitted on the SpCell:

4> indicate a Random Access problem to upper layers;

4> if this Random Access procedure was triggered for SI request:

5> consider the Random Access procedure unsuccessfully completed.

3> else if the Random Access Preamble is transmitted on a SCell:

4> consider the Random Access procedure unsuccessfully completed.

2> if the Random Access procedure is not completed:

3> select a random backoff time according to a uniform distribution between 0 and the PREAMBLE BACKOFF;

3> if the criteria to select contention-free Random Access Resources is met during the backoff time:

4> perform the Random Access Resource selection procedure;

3> else:

4> perform the Random Access Resource selection procedure after the backoff time.

The MAC entity may stop ra-ResponseWindow (and hence monitoring for Random Access Response(s)) after successful reception of a Random Access Response containing Random Access Preamble identifiers that matches the transmitted PREAMBLE_INDEX.

HARQ operation is not applicable to the Random Access Response transmission.

Contention Resolution is described.

Once Msg3 is transmitted, the MAC entity shall:

1> start the ra-ContentionResolutionTimer and restart the ra-ContentionResolutionTimer at each HARQ retransmission in the first symbol after the end of the Msg3 transmission;

1> monitor the PDCCH while the ra-ContentionResolutionTimer is running regardless of the possible occurrence of a measurement gap;

1> if notification of a reception of a PDCCH transmission of the SpCell is received from lower layers:

2> if the C-RNTI MAC CE was included in Msg3:

3> if the Random Access procedure was initiated by the MAC sublayer itself or by the RRC sublayer and the PDCCH transmission is addressed to the C-RNTI and contains a UL grant for a new transmission; or

3> if the Random Access procedure was initiated by a PDCCH order and the PDCCH transmission is addressed to the C-RNTI; or

3> if the Random Access procedure was initiated for beam failure recovery and the PDCCH transmission is addressed to the C-RNTI:

4> consider this Contention Resolution successful;

4> stop ra-ContentionResolutionTimer;

4> discard the TEMPORARY_C-RNTI;

4> consider this Random Access procedure successfully completed.

2> else if the CCCH SDU was included in Msg3 and the PDCCH transmission is addressed to its TEMPORARY C-RNTI:

3> if the MAC PDU is successfully decoded:

4> stop ra-ContentionResolutionTimer;

4> if the MAC PDU contains a UE Contention Resolution Identity MAC CE; and

4> if the UE Contention Resolution Identity in the MAC CE matches the CCCH SDU transmitted in Msg3:

5> consider this Contention Resolution successful and finish the disassembly and demultiplexing of the MAC PDU;

5> if this Random Access procedure was initiated for SI request:

6> indicate the reception of an acknowledgement for SI request to upper layers.

5> else:

6> set the C-RNTI to the value of the TEMPORARY_C-RNTI;

5> discard the TEMPORARY_C-RNTI;

5> consider this Random Access procedure successfully completed.

4> else:

5> discard the TEMPORARY_C-RNTI;

5> consider this Contention Resolution not successful and discard the successfully decoded MAC PDU.

1> if ra-ContentionResolutionTimer expires:

2> discard the TEMPORARY_C-RNTI;

2> consider the Contention Resolution not successful.

1> if the Contention Resolution is considered not successful:

2> flush the HARQ buffer used for transmission of the MAC PDU in the Msg3 buffer;

2> increment PREAMBLE NSMISSION_COUNTER by 1;

2> if PREAMBLE_TRANSMISSION_COUNTER=preambleTransMax+1:

3> indicate a Random Access problem to upper layers.

3> if this Random Access procedure was triggered for SI request:

4> consider the Random Access procedure unsuccessfully completed.

2> if the Random Access procedure is not completed:

3> select a random backoff time according to a uniform distribution between 0 and the PREAMBLE BACKOFF;

3> if the criteria to select contention-free Random Access Resources is met during the backoff time:

4> perform the Random Access Resource selection procedure;

3> else:

4> perform the Random Access Resource selection procedure after the backoff time.

Completion of the Random Access procedure is described.

Upon completion of the Random Access procedure, the MAC entity shall:

1> discard explicitly signalled contention-free Random Access Resources except contention-free Random Access Resources for beam failure recovery request, if any;

1> flush the HARQ buffer used for transmission of the MAC PDU in the Msg3 buffer.

Meanwhile, In RRC_IDLE or RRC_INACTIVE, a wireless device may not receive unicast downlink data before or without entering RRC_CONNECTED. A wireless device may receive unicast downlink data only after entering RRC_CONNECTED.

However, a wireless device may need to receive unicast downlink data before entering RRC_CONNECTED to receive the downlink data efficiently. Therefore, a method for receiving unicast downlink data before entering RRC_CONNECTED is required.

Hereinafter, a method and apparatus for receiving unicast downlink data before or without entering RRC_CONNECTED, according to some embodiments of the present disclosure, will be described.

According to some embodiments of the present disclosure, the method for a wireless device may be described as follow.

A wireless device may configure a UE RAN specific ID and one or more radio bearers with one or more Logical Channel ID (or one or more Radio Bearer ID) based on the configuration received from the network. For example, a Logical Channel ID (or each Radio Bearer ID) may correspond to one of the radio bearers. For example, each radio bearer may be identified by a Radio Bearer ID. For example, a UE RAN specific ID may be one of C-RNTI, I-RNTI and a new RNTI.

A wireless device may suspend radio bearers configured by the network upon leaving RRC_CONNECTED.

A wireless device may receive a Paging indicating a UE CN specific ID and the UE RAN specific ID and a Logical Channel ID (or a Radio Bearer ID) corresponding to one or more of the suspended radio bearers for Mobile Terminating Access. For example, a Paging may be one of Downlink Control Information of PDCCH or a Paging message. For example, a Paging may also indicate a RACH preamble. For example, a wireless device may receive the Paging in RRC_IDLE or RRC_INACTIVE.

Upon receiving the Paging, a wireless device may resume the logical channel indicated by the Logical Channel ID or the radio bearer indicated by the Radio Bearer ID while still suspending the other logical channel(s) (or the other radio bearers). In addition, a wireless device may initiate Random Access procedure and transmits a RACH preamble associated with the resumed Logical Channel (or the resumed Radio Bearer). For example, the RACH preamble may be indicated by the Paging.

A wireless device may monitor PDCCH addressed to the UE RAN specific ID to receive a Random Access Response message from the network. For example, the UE ID may be indicated by the Paging, by RRC Connection Release message, or by the received configuration.

A wireless device may receive a MAC PDU including downlink data based on the PDCCH as the Random Access Response message from the network, while in RRC_IDLE or RRC_INACTIVE. For example, the MAC PDU may include one or more MAC SDU including downlink data and the resumed Logical Channel ID (or the resumed Radio Bearer ID) and the UE RAN specific ID.

If a wireless device successfully decodes the MAC PDU, the wireless device may transmit uplink information indicating the Logical Channel ID (or the Radio Bearer ID) as RACH message 3 to the network as ACK to the MAC PDU.

Else, if a wireless device fails to decode the MAC PDU, the wireless device may not transmit uplink information e.g. indicating NACK or re-transmits the RACH preamble for NACK to the MAC PDU.

For example, when a network (for example, an eNB or gNB) transmits the MAC PDU, the network may start a timer. Upon timer expiry, if the uplink information has been not received, the network may consider transmission of the MAC PDU as unsuccessful. Then, the network may re-transmit the MAC PDU. For example, a wireless device may detect failure of decoding the MAC PDU based on CRC attached to the MAC PDU. For example, the uplink information is one of L1 Uplink Control Information, a MAC Control Element, RLC/PDCP Control PDU and a RRC message. The uplink information includes the UE RAN specific ID.

According to some embodiments of the present disclosure, if a wireless device fails to decode the MAC PDU, the wireless device may transmit uplink information indicating the Logical Channel ID (or the Radio Bearer ID) to the network as NACK to the MAC PDU.

Else if a wireless device successfully decodes the MAC PDU, the wireless device may not transmit uplink information indicating ACK or re-transmits the RACH preamble for ACK to the MAC PDU.

For example, when a network transmits the MAC PDU, the network may start a timer. Upon timer expiry, if the uplink information has been not received, the network may consider transmission of the MAC PDU as successful. Therefore, the network may not re-transmit the MAC PDU.

If a MAC PDU includes a MAC SDU corresponding to the resumed logical channel (or the resumed radio bearer) in downlink, UE MAC entity delivers the MAC SDU to upper layers. If the MAC PDU includes a MAC SDU corresponding to a suspended logical channel (or the suspended radio bearer) in downlink, UE MAC entity discards the MAC SDU, i.e. no delivery to upper layers.

If a wireless device receives a RRC Setup message and a RRC Resume message from the network, the wireless device may enter RRC_CONNECTED and then sends a RRC Setup Complete or a RRC Resume Complete message to the network. Or, if a wireless device receives an EarlyDataComplete message from the network, the wireless device may consider this procedure as successfully completed.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

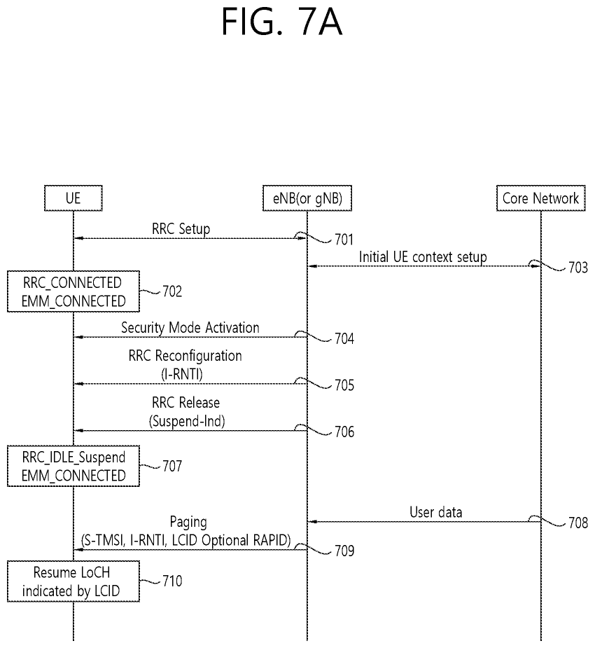

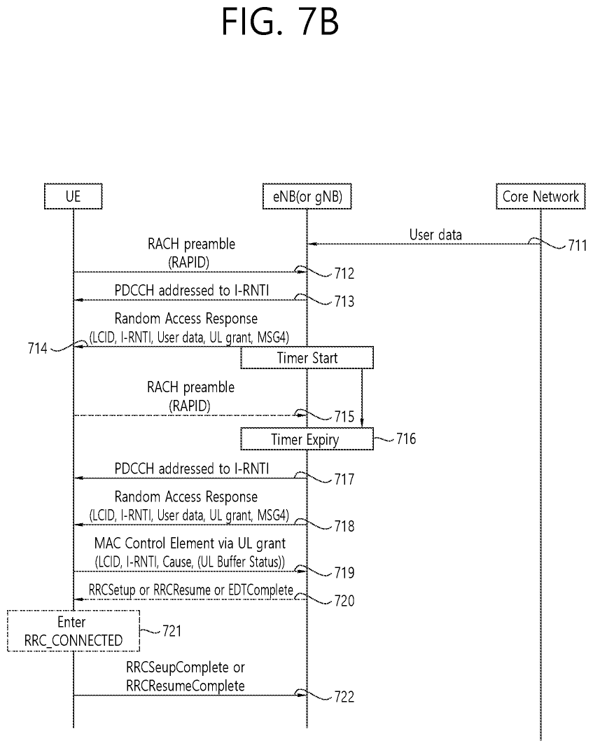

FIG. 7A and FIG. 7B show an example of a method for receiving unicast downlink data before or without entering RRC_CONNECTED, according to some embodiments of the present disclosure.

In step 701, a wireless device may receive configuration for RRC setup from a network (for example, from an eNB or a gNB).

In step 702, a wireless device may enter RRC_CONNECTED and EMM CONNECTED at a serving cell.

In step 703, an initial UE context may be setup between an eNB (or a gNB) and a core network.

In step 704, a wireless device may receive configuration for Security Mode Activation from a network. The wireless device may perform Security Mode Activation to activate AS security.

In step 705, a wireless device may receive RRC Connection Reconfiguration from the network to configure SPS configuration with inactive-RNTI (I-RNTI). The I-RNTI may be used for data transmission in RRC_INACTIVE or RRC_IDLE. The wireless device may receive SPS configuration via system information regardless of RRC state.

According to some embodiments of the present disclosure, a wireless device may configure a UE RAN specific ID and one or more radio bearers with one or more Logical Channel ID (or one or more Radio Bearer ID) based on the configuration received from the network. For example, each Logical Channel ID (or each Radio Bearer ID) corresponds to one of the radio bearers. For example, each radio bearer is identified by a Radio Bearer ID. For example, the UE RAN specific ID may be one of C-RNTI, I-RNTI and a new RNTI.

In step 706, a wireless device may receive a RRC Release from a network. The RRC Release message may include Suspend indication. The RRC Release message may include command to pre-allocated resource, such as configured grant or SPS.

In step 707, a wireless device may leave RRC_CONNECTED state. When a wireless device receives RRC Release message or RRC Release Indication (e.g. via PDCCH or MAC Control Element), the wireless device may leave RRC CONNETED and enter to RRC_IDLE. When a wireless device receives a RRC Release message with a suspend indication, the wireless device may leave RRC_CONNETED and enter to RRC_INACTIVE.

According to some embodiments of the present disclosure, a wireless device may suspend radio bearers configured by the network upon leaving RRC_CONNECTED.

In step 708, an eNB (or a gNB) may receive user data from a core network.

In step 709, a wireless device may receive a Paging indicating a UE CN specific ID and the UE RAN specific ID and a Logical Channel ID (or a Radio Bearer ID) corresponding to one or more of the suspended radio bearers for Mobile Terminating Access. The Paging is one of Downlink Control Information of PDCCH or a Paging message. The Paging also indicates a RACH preamble. The UE is in RRC_IDLE or RRC_INACTIVE.

In step 710, a wireless device may resume the logical channel indicated by the Logical Channel ID or the radio bearer indicated by the Radio Bearer ID while still suspending the other logical channel(s) (or the other radio bearers), upon receiving the Paging.

In step 711, an eNB (or a gNB) may receive user data from a core network. The user data may be transmit to the wireless device via unicast.

In step 712, a wireless device may initiate Random Access procedure and may transmit a RACH preamble associated with the resumed Logical Channel (or the resumed Radio Bearer). According to some embodiments of the present disclosure, the RACH preamble may be indicated by the Paging.

In step 713, a wireless device may monitor PDCCH addressed to the UE RAN specific ID to receive a Random Access Response (RAR) message from the network. The UE ID may be indicated by the Paging, by RRC Connection Release message, or by the received configuration.

In step 714, a wireless device may receive a RAR message from the network. A wireless device may receive a MAC PDU including downlink data based on the PDCCH as the RAR message from the network, while in RRC_IDLE or RRC_INACTIVE. The MAC PDU may include one or more MAC SDU including downlink data, the resumed Logical Channel ID (or the resumed Radio Bearer ID), and/or the UE RAN specific ID.

In step 715, if the wireless device fails to decode the MAC PDU, the wireless device may not transmit uplink information e.g. indicating NACK or transmits a RACH preamble indicating NACK to the MAC PDU.

The wireless device may detect failure of decoding the MAC PDU based on CRC attached to the MAC PDU.

In step 714, an eNB (or a gNB) may start a timer, when the eNB transmits the MAC PDU. In step 716, upon the timer expiry, if the uplink information has been not received, the eNB may consider transmission of the MAC PDU as unsuccessful. In step 717 and step 718, the eNB may re-transmit the MAC PDU, similar as step 713 and step 714.

In step 719, if a wireless device successfully decodes the MAC PDU, the wireless device may transmit uplink information indicating the Logical Channel ID (or the Radio Bearer ID), as RACH message 3 to the network, as ACK to the MAC PDU.

The uplink information may be one of L1 Uplink Control Information, a MAC Control Element, RLC/PDCP Control PDU and a RRC message. The uplink information may include the UE RAN specific ID.

Alternatively, in step 715, if a wireless device fails to decode the MAC PDU, the wireless device may transmit uplink information indicating the Logical Channel ID (or the Radio Bearer ID) to the network as NACK to the MAC PDU.

In step 719, if a wireless device successfully decodes the MAC PDU, the wireless device may not transmit uplink information indicating ACK or transmits a RACH preamble indicating ACK to the MAC PDU.

In this case, in step 714 an eNB may start a timer, when eNB transmits the MAC PDU. In step 716, upon timer expiry, if the uplink information has been not received, an eNB may consider transmission of the MAC PDU as successful. Therefore, an eNB may not re-transmit the MAC PDU.

According to some embodiments of the present disclosure, the uplink information is transmitted via Uplink Grant received from the Random Access Response message. The uplink information may be a MAC Control Element including the Logical Channel ID, the UE RAN specific ID, a Cause and UL buffer status. The Cause may be equal to one value of EstablishmentCause of RRC Connection Request message and ResumeCause of RRC Connection Resume Request message, e.g. MT access, MO data, MO siganling, an Access Category, High priority access, Emergency Access, Delay tolerant access, voice call and video call.

If the MAC PDU includes a MAC SDU corresponding to the resumed logical channel (or the resumed radio bearer) in downlink, MAC entity of the wireless device may deliver the MAC SDU to upper layers. If the MAC PDU includes a MAC SDU corresponding to a suspended logical channel (or the suspended radio bearer) in downlink, the MAC entity of the wireless device may discard the MAC SDU, i.e. no delivery to upper layers.

According to some embodiments of the present disclosure, the received Random Access Response (RAR) message may indicate whether Message 4 is transmitted or not. If the RAR message indicates that Message 4 is transmitted, a wireless device may monitor transmission of the Message 4. If The RAR message indicates that Message 4 is not transmitted, a wireless device may stop this procedure.

In step 720, a wireless device may receive a RRC Setup message or a RRC Resume message from the network, when the RAR message indicates that Message 4 is transmitted.

In step 721, if a wireless device receives a RRC Setup message or a RRC Resume message from the network, the wireless device may enter RRC_CONNECTED.

In step 722, the wireless device may transmit a RRC Setup Complete or a RRC Resume Complete message to the network.

According to some embodiments of the present disclosure, in step 720, a wireless device may receive an EarlyDataComplete message from the network, when the RAR message indicates that Message 4 is transmitted. In this case, the wireless device may consider this procedure as successfully completed.

According to some embodiments of the present disclosure, a wireless device may communicate with a network efficiently, since the wireless device resumes some logical channel(s) while still suspending other logical channel(s).

According to some embodiments of the present disclosure, a wireless device may save an effort, such as time or battery, for monitoring a message 4 from the network, when a RAR message indicates that the message 4 is not transmitted.

Meanwhile, in the NR, an initial access procedure may include various element technologies to support multi-beam transmission and broadband. Due to the inherent characteristics of the NR, the initial access procedure of the NR may be different from the initial access procedure in the conventional 3GPP LTE/LTE-A. Therefore, studies for a more efficient initial access procedure are still needed.

Herein after, a method and apparatus for performing a more efficient initial access in a wireless communication system, according to some embodiments of the present disclosure, will be described. More specifically, a method and apparatus for random access procedure with an acknowledgement, according to some embodiments of the present disclosure, will be described.

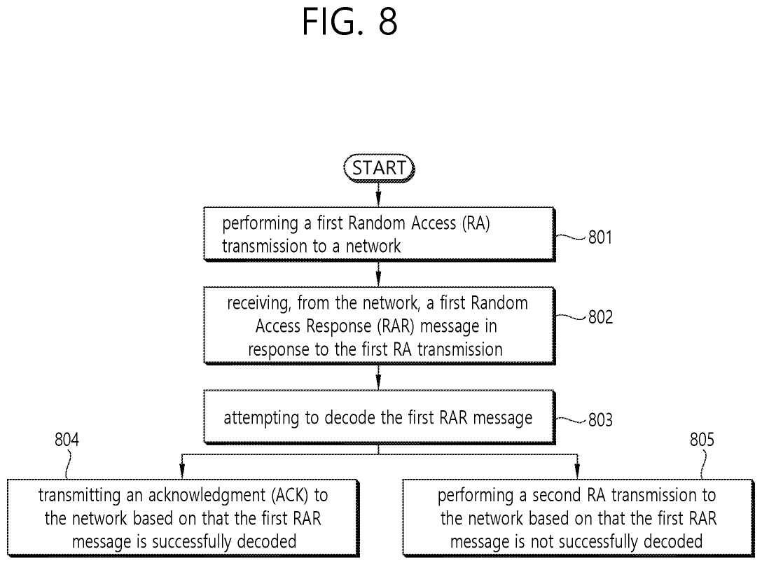

FIG. 8 shows an example of a method for random access procedure according to some embodiments of the present disclosure.

In step 801, a wireless device may perform a first Random Access (RA) transmission to a network. For example, the first RA transmission may include transmitting a RA preamble. That is, a wireless may transmit a RA preamble to the network.

In step 802, a wireless device may receive, from the network, a first Random Access Response (RAR) message in response to the first RA transmission.

According to some embodiments of the present disclosure, the first RAR message may include an information related to the first RA preamble from the wireless device, such as RA preamble indication (RAPID). However, the present disclosure are not limited thereto.

In step 803, a wireless device may attempt to decode the first RAR message. A wireless device may determine whether the first RAR message is successfully decoded or not based on a Cyclic Redundancy Check (CRC) which is attached to the first RAR message.

According to some embodiments of the present disclosure, a wireless device may determine whether the first RAR message is successfully decoded or not based on that the first RAR message includes an information related to the RA preamble, transmitted by the wireless device.

In step 804, a wireless device may transmit an acknowledgment (ACK) (or a positive ACK) to the network based on that the first RAR message is successfully decoded. For example, an ACK may be a L1 Uplink Control Information and/or a MAC Control Element. For example, an ACK may be a RLC Control PDU, a PDCP Control PDU, and/or a RRC message.

In step 805, a wireless device may perform a second RA transmission to the network based on that the first RAR message is not successfully decoded. For example, a wireless device may transmit a RA preamble, as a NACK (or a negative ACK), to the network based on that the first RAR message is not successfully decoded. In this case, the network may transmit other RAR message in response to the second RA transmission.

According to some embodiments of the present disclosure, a wireless device may receive a second RAR message, in response to the first RA transmission, as a retransmission of the first RAR message from the network. The network may retransmit the second RAR message in response to the first RA transmission, before receiving an ACK for the first RAR message or a second RA transmission from the wireless device. The wireless device may receive the second RAR message before transmitting an ACK or performing a second RA transmission to the network.

When the wireless device receives the second RAR message, the wireless device may attempt to decode the second RAR message. The wireless device may transmit an ACK for the second RAR message to the network based on that the second RAR message is successfully decoded. The wireless may perform a RA transmission to the network, as a NACK, for the second RAR message, based on that the second RAR message is not successfully decoded.

According to some embodiments of the present disclosure, a RAR message may inform that whether a message 4 is transmitted or not to a wireless device from the network. The message 4 may be transmitted, from the network, in response to an ACK of the wireless device for the RAR message. The message 4 may be a RRC Setup message, a RRC Resume message, and/or an EarlyDataComplete message. In this case, a wireless device may determine whether to monitor the message 4 based on the received RAR message.

For example, a wireless device may monitor a transmission of the message 4 based on the RAR message informing that the message 4 is transmitted from the network.

For other example, a wireless device may not monitor a transmission of the message 4 based on the RAR message informing that the message 4 is not transmitted from the network. In this case, the wireless device may stop to monitor the transmission of the message 4. The wireless device may skip to monitor a transmission of the message 4 based on the RAR message informing that the message 4 is not transmitted from the network.

According to some embodiments of the present disclosure, there are one or more of wireless devices performing random access transmission to a network (for example, an eNB or a gNB). Hereinafter, for convenience of the explanation, an UE_A and an UE_B will be described as an example of wireless devices which perform random access transmission to the network. However, the present disclosure are not limited thereto. There are more than two wireless devices performing random access transmission to a network.

In step 801, the UE_A may perform a first RA transmission (for example, a first RA transmission_A), such as transmitting a RA preamble, to the network. The UE_B may also perform a first RA transmission (for example, a first RA transmission B), such as transmitting a RA preamble, to the network. For example, the first RA preamble ID of the UE_A (for example, RAPID_A) may be different from the second RA preamble ID of the UE_B (for example, RAPID_B).

In step 802, the UE_A may receive the first RAR message from the network in response to the first RA transmission A. The UE_B may also receive the first RAR message from the network in response to the first RA transmission_B. That is, the UE_A and the UE_B may receive the same RAR message. In other words, the first RAR message may be transmitted from the network, in response to both of the first RA transmission_A and the first RA transmission_B.

According to some embodiments of the present disclosure, the first RAR message may include an information related to the RA preamble of the UE_A, such as a RAPID_A. The first RAR message may also include an information related to the RA preamble of the UE_B, such as a RAPID_B. For example, the first RAR message may include both of the RAPID_A and the RAPID_B. For other example, the first RAR message may only include the RAPID_A and may not include the RAPID_B.

In step 803, the UE_A may attempt to decode the first RAR message. The UE_A may perform a cyclic redundancy check (CRC) test to the first RAR message with the CRC attached to the first RAR message. If the first RAR message does not pass the CRC test, the UE_A may determine that the first RAR message is not successfully decoded. Else, if the first RAR message passes the CRC test, the UE_A may determine that the first message is successfully decoded. The UE_B may also attempt to decode the first RAR message. The UE_B may also determine whether the first RAR message is successfully decoded or not, in similar way with the UE_A.

According to some embodiments of the present disclosure, the UE_A may determine that the first RAR message is successfully decoded, when the first RAR message includes the RAPID_A. The UE_B may determine that the first RAR message is successfully decoded, when the first RAR message includes the RAPID_B.

For example, when the first RAR message includes both of the RAPID_A and the RAPID_B, both of the UE_A and the UE_B may determine that the first RAR message is successfully decoded, respectively.

For other example, when the first RAR message includes the RAPID_A and does not include the RAPID_B, the UE_A may determine that the first RAR message is successfully decoded. However, the UE_B may determine that the first RAR message is not successfully decoded.

For another example, when the first RAR message includes the RAPID_B and does not include the RAPID_A, the UE_A may determine that the first RAR message is not successfully decoded. However, the UE_B may determine that the first RAR message is successfully decoded.

In step 804, the UE_A and the UE_B may transmit an ACK to the network based on that the first RAR message is successfully decoded, respectively. In step 805, the UE_A and the UE_B may perform a second RA transmission, respectively.

For example, both of the UE_A and the UE_B may transmit an ACK to the network, when the first RAR message include both of the RAPID_A and the RAPID B.

For other example, both of the UE_A and the UE_B may perform a second RA transmission, when the first RAR message do not include both of the RAPID_A and the RAPID_B.

For another example, the UE_A and the UE_B may perform different procedure. The UE_A may transmit an ACK to the network based on that the first RAR message is successfully decoded. However, the UE_B may perform a second RA transmission (for example, a second RA transmission_B), as a NACK for the first RAR message, based on that the first RAR message is not successfully decoded.

According to some embodiments of the present disclosure, the UE_A may receive a second RAR message, in response to the first RA transmission, as a retransmission of the first RAR message.

For example, both of the UE_A and the UE_B may transmit a first RA transmission, respectively. The UE_A and the UE_B may receive a first RAR message, respectively. The UE_B may transmit an ACK for the first RAR message to the network, before the UE_A attempt to decode the first RAR message. Otherwise, the UE_B may transmit an ACK for the first RAR message to the network before the UE_A transmits an ACK or performs the second RA transmission to the network.

In this case, the network may transmit a second RAR message as a retransmission of the first RAR message. The network may configure the second RAR message to include only the RAPID_A and not include the RAPID B, since the UE_B has decoded the first RAR message successfully. That is, the second RAR message may be different from the first RAR message.

When the UE_A receives the second RAR message, the UE_A may attempt to decode the second RAR message. The UE_A may transmit an ACK for the second RAR message to the network based on that the second RAR message is successfully decoded. The UE_A may perform another RA transmission to the network, as a NACK for the second RAR message, based on that the second RAR message is not successfully decoded.

Furthermore, the UE_B may not receive the second RAR message, after transmitting an ACK for the first RAR message. The UE_B may not monitor to receive the second RAR message, after transmitting the ACK for the first RAR message.

According to some embodiments of the present disclosure, the methods described in the present disclosure may be applied to a simplified random access procedure (for example, 2-step random access procedure). The methods described in the present disclosures could make the simplified random access procedure more efficiently.

For example, a wireless device may perform a first RA transmission, as a message A in the 2-step RA procedure, to a network. The wireless device may receive, from the network, a RAR message, as a message B in the 2-step RA procedure, in response to the first RA transmission. The wireless device may attempt to decode the first RAR message. The wireless device may transmit an ACK, for the message B, to the network based on that the first RAR message is successfully decoded. The wireless device may perform a second RA transmission to the network based on that the first RAR message is not successfully decoded.

Furthermore, according to some embodiments of the present disclosure, the RAR message may inform that the wireless device perform whether a 4-step RA procedure or a 2-step RA procedure. When the RAR message informs that a message 4 is not transmitted, the wireless device may consider to proceed the 2-step RA procedure. When the RAR message informs that a message 4 is transmitted, the wireless device may consider to proceed the 4-step RA procedure. However, the present disclosure is not limited thereto.

According to some embodiments of the present disclosure, a wireless device may save an effort, such as a time and a battery, for decoding the second RAR message after transmitting an ACK for the first RAR message.

According to some embodiments of the present disclosure, a network may save a resource, for configuring a RAR message by considering ACK(s) from one or more of wireless device(s).

According to some embodiments of the present disclosure, a network may save a resource for a message 4 when the message 4 is not needed. In addition, a wireless device may save a time and a battery for monitoring the message 4.

In the present disclosure, some embodiments which are described above can be combined with each other. For example, the embodiments described with reference to the FIG. 7A, FIG. 7B, and the FIG. 8 could be combined with each other.

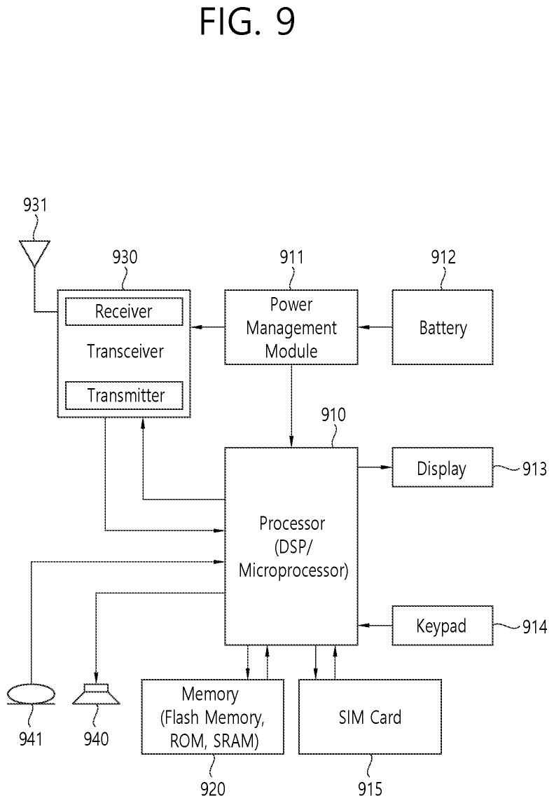

FIG. 9 shows an apparatus to which the technical features of the present disclosure can be applied. The description of the same or similar features described above could be omitted or simplified, for convenience of explanation.

An apparatus may be referred as a wireless device, such as a user equipment (UE), an Integrated Access and Backhaul (IAB), or etc.

A wireless device includes a processor 910, a power management module 911, a battery 912, a display 913, a keypad 914, a subscriber identification module (SIM) card 915, a memory 920, a transceiver 930, one or more antennas 931, a speaker 940, and a microphone 941.

The processor 910 may be configured to implement proposed functions, procedures and/or methods described in this description. Layers of the radio interface protocol may be implemented in the processor 910. The processor 910 may include application-specific integrated circuit (ASIC), other chipset, logic circuit and/or data processing device. The processor 910 may be an application processor (AP). The processor 910 may include at least one of a digital signal processor (DSP), a central processing unit (CPU), a graphics processing unit (GPU), a modem (modulator and demodulator). An example of the processor 910 may be found in SNAPDRAGON™ series of processors made by Qualcomm®, EXYNOS™ series of processors made by Samsung®, a series of processors made by Apple®, HELIO™ series of processors made by MediaTek®, ATOM™ series of processors made by Intel® or a corresponding next generation processor.

The power management module 911 manages power for the processor 910 and/or the transceiver 930. The battery 912 supplies power to the power management module 911. The display 913 outputs results processed by the processor 910. The keypad 914 receives inputs to be used by the processor 910. The keypad 914 may be shown on the display 913. The SIM card 915 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 920 is operatively coupled with the processor 910 and stores a variety of information to operate the processor 910. The memory 920 may include read-only memory (ROM), random access memory (RAM), flash memory, memory card, storage medium and/or other storage device. When the embodiments are implemented in software, the techniques described herein can be implemented with modules (e.g., procedures, functions, and so on) that perform the functions described herein. The modules can be stored in the memory 920 and executed by the processor 910. The memory 920 can be implemented within the processor 910 or external to the processor 910 in which case those can be communicatively coupled to the processor 910 via various means as is known in the art.

The transceiver 930 is operatively coupled with the processor 910, and transmits and/or receives a radio signal. The transceiver 930 includes a transmitter and a receiver. The transceiver 930 may include baseband circuitry to process radio frequency signals. The transceiver 930 controls the one or more antennas 931 to transmit and/or receive a radio signal.

The speaker 940 outputs sound-related results processed by the processor 910. The microphone 941 receives sound-related inputs to be used by the processor 910.

According to some embodiments of the present disclosure, the processor 910 may be configured to be coupled operably with the memory 920 and the transceiver 930. The processor 910 may be configured to perform a first Random Access (RA) transmission to a network. The processor 910 may be configured to control the transceiver 930 to receive, from the network, a first Random Access Response (RAR) message in response to the first RA transmission. The processor 910 may be configured to attempt to decode the first RAR message. The processor 910 may be configured to control the transceiver 930 to transmit an acknowledgment (ACK) to the network based on that the first RAR message is successfully decoded. The processor 910 may be configured to perform a second RA transmission to the network based on that the first RAR message is not successfully decoded.

According to some embodiments of the present disclosure, the first RAR message informs whether a message 4 is transmitted or not from the network. For example, the processor 910 may be configured to monitor the transmission of the message 4 based on that the first RAR message informs that the message 4 is transmitted from the network. For other example, the processor 910 may be configured to skip to monitor the transmission of the message 4 based on that the first RAR message informs that the message 4 is not transmitted from the network.

According to some embodiments of the present disclosure, a wireless device may save a time and a battery consumed to decode the second RAR message, by transmitting an ACK for the first RAR message.

According to some embodiments of the present disclosure, a wireless device may save a time and a battery for monitoring the message 4.

The present disclosure may be applied to various future technologies, such as AI, robots, autonomous-driving/self-driving vehicles, and/or extended reality (XR).

<AI>

AI refers to artificial intelligence and/or the field of studying methodology for making it. Machine learning is a field of studying methodologies that define and solve various problems dealt with in AI. Machine learning may be defined as an algorithm that enhances the performance of a task through a steady experience with any task.

An artificial neural network (ANN) is a model used in machine learning. It can mean a whole model of problem-solving ability, consisting of artificial neurons (nodes) that form a network of synapses. An ANN can be defined by a connection pattern between neurons in different layers, a learning process for updating model parameters, and/or an activation function for generating an output value. An ANN may include an input layer, an output layer, and optionally one or more hidden layers. Each layer may contain one or more neurons, and an ANN may include a synapse that links neurons to neurons. In an ANN, each neuron can output a summation of the activation function for input signals, weights, and deflections input through the synapse. Model parameters are parameters determined through learning, including deflection of neurons and/or weights of synaptic connections. The hyper-parameter means a parameter to be set in the machine learning algorithm before learning, and includes a learning rate, a repetition number, a mini batch size, an initialization function, etc. The objective of the ANN learning can be seen as determining the model parameters that minimize the loss function. The loss function can be used as an index to determine optimal model parameters in learning process of ANN.

Machine learning can be divided into supervised learning, unsupervised learning, and reinforcement learning, depending on the learning method. Supervised learning is a method of learning ANN with labels given to learning data. Labels are the answers (or result values) that ANN must infer when learning data is input to ANN. Unsupervised learning can mean a method of learning ANN without labels given to learning data. Reinforcement learning can mean a learning method in which an agent defined in an environment learns to select a behavior and/or sequence of actions that maximizes cumulative compensation in each state.

Machine learning, which is implemented as a deep neural network (DNN) that includes multiple hidden layers among ANN, is also called deep learning. Deep learning is part of machine learning. In the following, machine learning is used to mean deep learning.

<Robot>

A robot can mean a machine that automatically processes or operates a given task by its own abilities. In particular, a robot having a function of recognizing the environment and performing self-determination and operation can be referred to as an intelligent robot. Robots can be classified into industrial, medical, household, military, etc., depending on the purpose and field of use. The robot may include a driving unit including an actuator and/or a motor to perform various physical operations such as moving a robot joint. In addition, the movable robot may include a wheel, a break, a propeller, etc., in a driving unit, and can travel on the ground or fly in the air through the driving unit.

<Autonomous-Driving/Self-Driving>

The autonomous-driving refers to a technique of self-driving, and an autonomous vehicle refers to a vehicle that travels without a user's operation or with a minimum operation of a user. For example, autonomous-driving may include techniques for maintaining a lane while driving, techniques for automatically controlling speed such as adaptive cruise control, techniques for automatically traveling along a predetermined route, and techniques for traveling by setting a route automatically when a destination is set. The autonomous vehicle may include a vehicle having only an internal combustion engine, a hybrid vehicle having an internal combustion engine and an electric motor together, and an electric vehicle having only an electric motor, and may include not only an automobile but also a train, a motorcycle, etc. The autonomous vehicle can be regarded as a robot having an autonomous driving function.

<XR>

XR are collectively referred to as VR, AR, and MR. VR technology provides real-world objects and/or backgrounds only as computer graphic (CG) images, AR technology provides CG images that is virtually created on real object images, and MR technology is a computer graphics technology that mixes and combines virtual objects in the real world. MR technology is similar to AR technology in that it shows real and virtual objects together. However, in the AR technology, the virtual object is used as a complement to the real object, whereas in the MR technology, the virtual object and the real object are used in an equal manner. XR technology can be applied to HMD, head-up display (HUD), mobile phone, tablet PC, laptop, desktop, TV, digital signage. A device to which the XR technology is applied may be referred to as an XR device.

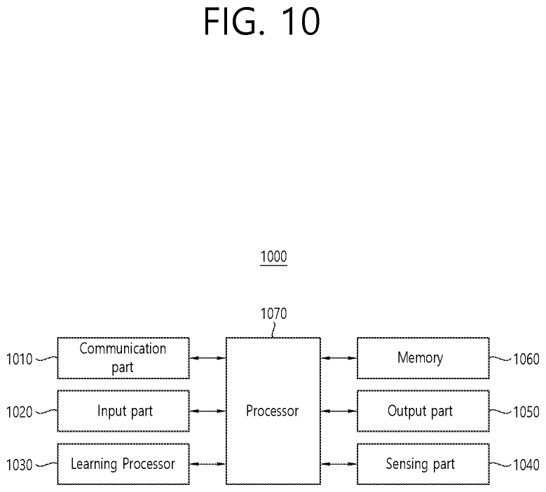

FIG. 10 shows an example of an AI device to which the technical features of the present disclosure can be applied.

The AI device 1000 may be implemented as a stationary device or a mobile device, such as a TV, a projector, a mobile phone, a smartphone, a desktop computer, a notebook, a digital broadcasting terminal, a PDA, a PMP, a navigation device, a tablet PC, a wearable device, a set-top box (STB), a digital multimedia broadcasting (DMB) receiver, a radio, a washing machine, a refrigerator, a digital signage, a robot, a vehicle, etc.

Referring to FIG. 10, the AI device 1000 may include a communication part 1010, an input part 1020, a learning processor 1030, a sensing part 1040, an output part 1050, a memory 1060, and a processor 1070.

The communication part 1010 can transmit and/or receive data to and/or from external devices such as the AI devices and the AI server using wire and/or wireless communication technology. For example, the communication part 1010 can transmit and/or receive sensor information, a user input, a learning model, and a control signal with external devices. The communication technology used by the communication part 1010 may include a global system for mobile communication (GSM), a code division multiple access (CDMA), an LTE/LTE-A, a 5G, a WLAN, a Wi-Fi, Bluetooth™, radio frequency identification (RFID), infrared data association (IrDA), ZigBee, and/or near field communication (NFC).

The input part 1020 can acquire various kinds of data. The input part 1020 may include a camera for inputting a video signal, a microphone for receiving an audio signal, and a user input part for receiving information from a user. A camera and/or a microphone may be treated as a sensor, and a signal obtained from a camera and/or a microphone may be referred to as sensing data and/or sensor information. The input part 1020 can acquire input data to be used when acquiring an output using learning data and a learning model for model learning. The input part 1020 may obtain raw input data, in which case the processor 1070 or the learning processor 1030 may extract input features by preprocessing the input data.

The learning processor 1030 may learn a model composed of an ANN using learning data. The learned ANN can be referred to as a learning model. The learning model can be used to infer result values for new input data rather than learning data, and the inferred values can be used as a basis for determining which actions to perform. The learning processor 1030 may perform AI processing together with the learning processor of the AI server. The learning processor 1030 may include a memory integrated and/or implemented in the AI device 1000. Alternatively, the learning processor 1030 may be implemented using the memory 1060, an external memory directly coupled to the AI device 1000, and/or a memory maintained in an external device.

The sensing part 1040 may acquire at least one of internal information of the AI device 1000, environment information of the AI device 1000, and/or the user information using various sensors. The sensors included in the sensing part 1040 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a light detection and ranging (LIDAR), and/or a radar.

The output part 1050 may generate an output related to visual, auditory, tactile, etc. The output part 1050 may include a display for outputting visual information, a speaker for outputting auditory information, and/or a haptic module for outputting tactile information.

The memory 1060 may store data that supports various functions of the AI device 1000. For example, the memory 1060 may store input data acquired by the input part 1020, learning data, a learning model, a learning history, etc.

The processor 1070 may determine at least one executable operation of the AI device 1000 based on information determined and/or generated using a data analysis algorithm and/or a machine learning algorithm. The processor 1070 may then control the components of the AI device 1000 to perform the determined operation. The processor 1070 may request, retrieve, receive, and/or utilize data in the learning processor 1030 and/or the memory 1060, and may control the components of the AI device 1000 to execute the predicted operation and/or the operation determined to be desirable among the at least one executable operation. The processor 1070 may generate a control signal for controlling the external device, and may transmit the generated control signal to the external device, when the external device needs to be linked to perform the determined operation. The processor 1070 may obtain the intention information for the user input and determine the user's requirements based on the obtained intention information. The processor 1070 may use at least one of a speech-to-text (STT) engine for converting speech input into a text string and/or a natural language processing (NLP) engine for acquiring intention information of a natural language, to obtain the intention information corresponding to the user input. At least one of the STT engine and/or the NLP engine may be configured as an ANN, at least a part of which is learned according to a machine learning algorithm. At least one of the STT engine and/or the NLP engine may be learned by the learning processor 1030 and/or learned by the learning processor of the AI server, and/or learned by their distributed processing. The processor 1070 may collect history information including the operation contents of the AI device 1000 and/or the user's feedback on the operation, etc. The processor 1070 may store the collected history information in the memory 1060 and/or the learning processor 1030, and/or transmit to an external device such as the AI server. The collected history information can be used to update the learning model. The processor 1070 may control at least some of the components of AI device 1000 to drive an application program stored in memory 1060. Furthermore, the processor 1070 may operate two or more of the components included in the AI device 1000 in combination with each other for driving the application program.

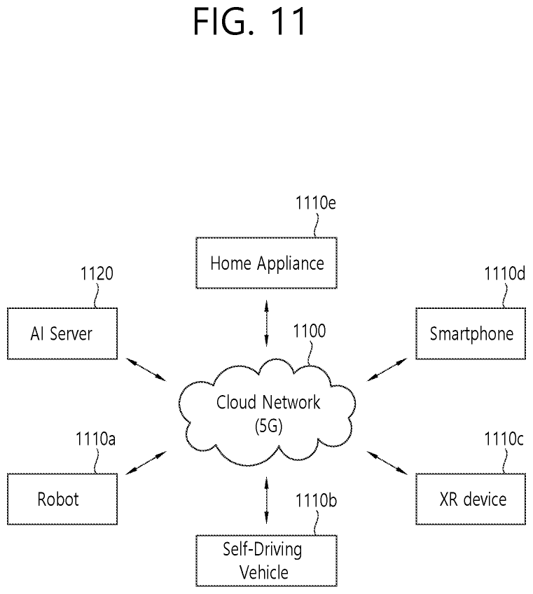

FIG. 11 shows an example of an AI system to which the technical features of the present disclosure can be applied.

Referring to FIG. 11, in the AI system, at least one of an AI server 1120, a robot 1110a, an autonomous vehicle 1110b, an XR device 1110c, a smartphone 1110d and/or a home appliance 1110e is connected to a cloud network 1100. The robot 1110a, the autonomous vehicle 1110b, the XR device 1110c, the smartphone 1110d, and/or the home appliance 1110e to which the AI technology is applied may be referred to as AI devices 1110a to 1110e.

The cloud network 1100 may refer to a network that forms part of a cloud computing infrastructure and/or resides in a cloud computing infrastructure. The cloud network 1100 may be configured using a 3G network, a 4G or LTE network, and/or a 5G network. That is, each of the devices 1110a to 1110e and 1120 consisting the AI system may be connected to each other through the cloud network 1100. In particular, each of the devices 1110a to 1110e and 1120 may communicate with each other through a base station, but may directly communicate with each other without using a base station.

The AI server 1120 may include a server for performing AI processing and a server for performing operations on big data. The AI server 1120 is connected to at least one or more of AI devices constituting the AI system, i.e. the robot 1110a, the autonomous vehicle 1110b, the XR device 1110c, the smartphone 1110d and/or the home appliance 1110e through the cloud network 1100, and may assist at least some AI processing of the connected AI devices 1110a to 1110e. The AI server 1120 can learn the ANN according to the machine learning algorithm on behalf of the AI devices 1110a to 1110e, and can directly store the learning models and/or transmit them to the AI devices 1110a to 1110e. The AI server 1120 may receive the input data from the AI devices 1110a to 1110e, infer the result value with respect to the received input data using the learning model, generate a response and/or a control command based on the inferred result value, and transmit the generated data to the AI devices 1110a to 1110e. Alternatively, the AI devices 1110a to 1110e may directly infer a result value for the input data using a learning model, and generate a response and/or a control command based on the inferred result value.

Various embodiments of the AI devices 1110a to 1110e to which the technical features of the present disclosure can be applied will be described. The AI devices 1110a to 1110e shown in FIG. 11 can be seen as specific embodiments of the AI device 1000 shown in FIG. 10.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-15. (canceled)

16. A method performed by a wireless device configured to operate in a wireless communication, the method comprising:
initiating a random access procedure;
transmitting, to a network, a random access channel (RACH) preamble; and
receiving, from the network, a random access response message in response to the RACH preamble,
wherein the random access response message includes information informing whether a subsequent message of the random access procedure is remained or not.

17. The method of claim 16, wherein the random access response message includes a cell radio network temporary identifier (C-RNTI) specified to the wireless device.

18. The method of claim 16, wherein the random access response message is included in a media access control (MAC) protocol data unit (PDU) transmitted from the network, and
wherein the MAC PDU further includes one or more media access control (MAC) service data units (SDUs) including downlink data and a logical channel identifier (LCID).

19. The method of claim 16, wherein the method further comprises,
transmitting, to the network, the subsequent message of the random access procedure based on that the information included in the random access response message informs that the subsequent message of the random access procedure is remained.

20. The method of claim 16, wherein the method further comprises,
monitoring the subsequent message of the random access procedure based on that the information included in the random access response message informs that the subsequent message of the random access procedure is remained.

21. The method of claim 16, wherein the method further comprises,
stopping the random access procedure based on that the information included in the random access response message informs that the subsequent message of the random access procedure is not remained.

22. The method of claim 16, wherein the subsequent message of the random access procedure is a message 3 of the random access procedure.

23. The method of claim 16, wherein the subsequent message of the random access procedure is one of a radio resource control (RRC) Setup message, a RRC Resume message, and/or an EarlyDataComplete message from the network.

24. The method of claim 16, wherein the method further comprises,
determining whether the random access response message is successfully decoded or not based on a Cyclic Redundancy Check (CRC) which is attached to the random access response message.

25. The method of claim 16, wherein the wireless device is an autonomous driving apparatus in communication with at least one of a mobile terminal, a network, and/or autonomous vehicles other than the wireless device.

26. A wireless device configured to operate in a wireless communication system, the wireless device comprising:
at least one transceiver;
at least one processor; and
at least one computer memory operably connectable to the at least one processor and storing instructions that, based on being executed by the at least one processor, perform operations comprising:
initiating a random access procedure;
transmitting, to a network, a random access channel (RACH) preamble; and
receiving, from the network, a random access response message in response to the RACH preamble,
wherein the random access response message includes information informing whether a subsequent message of the random access procedure is remained or not.

27. The wireless device of claim 26, wherein the random access response message includes a cell radio network temporary identifier (C-RNTI) specified to the wireless device.

28. The wireless device of claim 26, wherein the random access response message is included in a media access control (MAC) protocol data unit (PDU) transmitted from the network, and
wherein the MAC PDU further includes one or more media access control (MAC) service data units (SDUs) including downlink data and a logical channel identifier (LCID).

29. The wireless device of claim 26, wherein the operations further comprises,
transmitting, to the network, the subsequent message of the random access procedure based on that the information included in the random access response message informs that the subsequent message of the random access procedure is remained.

30. An apparatus configured to operate in a wireless communication system, the apparatus comprising:
at least one processor; and
at least one memory coupled to the at least one processor,
wherein the at least one processor is configured to perform operations comprising:
initiating a random access procedure;
generating a random access channel (RACH) preamble; and
obtaining a random access response message in response to the RACH preamble,
wherein the random access response message includes information informing whether a subsequent message of the random access procedure is remained or not.
